(19) United States
(12) Patent Application Publication
(10) Pub. No.: US 2025/0153563 A1
(43) Pub. Date: May 15, 2025

(54) AXLE ASSEMBLY DEVICES, SYSTEMS, AND METHODS

(71) Applicant: ArvinMeritor Technology, LLC, Troy, MI (US)

(72) Inventors: Brian Hayes, Troy, MI (US); Andrew Bodary, Troy, MI (US)

(21) Appl. No.: 18/949,195

(22) Filed: Nov. 15, 2024

Related U.S. Application Data
(60) Provisional application No. 63/599,242, filed on Nov. 15, 2023.

(51) Int. Cl. B60K 17/16; B60B 35/16; B60K 1/00; B60K 17/02; B60K 17/08; F16H 37/08; F16H 57/02; F16H 57/023; F16H 57/037

(52) U.S. Cl. CPC B60K 17/165; B60B 35/16; B60K 1/00; B60K 17/02; B60K 17/08; F16H 37/0813; F16H 37/082; F16H 57/023; F16H 57/037; B60K 2001/001; F16H 2057/02026; F16H 2057/02034; F16H 2057/02052

(57) ABSTRACT

In implementations, a method includes receiving a torque that is provided along a first axis at a first portion of the axle assembly that is forward of an axle axis along which at least one axis of the axle assembly is receivable. In addition, the method includes transmitting the torque from the first axis to a second axis that is parallelly offset from the first axis, each of the first and second axes being angled relative to the axle axis. The method includes engaging a differential assembly at a second portion of the axle assembly that is opposite the first portion to thereby provide the torque to one or more traction wheel assemblies that are operatively connected to the axle assembly.

### CROSS-REFERENCE TO RELATED APPLICATION

This application claims priority to U.S. Provisional Application No. 63/599,242, filed Nov. 15, 2023, which is herein incorporated by reference in its entirety.

### TECHNICAL FIELD

The present disclosure generally relates to axle assemblies, and in particular, compact axle assemblies include an electric motor and a gear reduction module that transmits torque from the electric motor to a differential.

### BACKGROUND

High demands for electric driven and hybrid electric assisted vehicles have driven innovation in the industry. Hybrid electric vehicles use electric motor driven axles, which can be implemented in multi-axle configurations in vehicle systems such as military and specialty platforms. Primarily sized to meet both torque and speed requirements, these electric motors may not be the most effective or size-efficient for the operational requirements of such vehicles. For instance, large electric motors used to meet the torque requirements may result in an oversized motor for most operational conditions. Moreover, the large electric motors may be difficult to package in a multi-axle vehicle configuration as their footprint can encroach on otherwise usable space or cause otherwise absent design constraints.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, axle assembly may include an axle housing that is configured to support at least one axle shaft along an axle shaft axis. Axle assembly may also include a differential assembly that is supported by the axle housing and transmits torque to a vehicle traction wheel assembly. Assembly may furthermore include a drive pinion that is operatively engages the differential assembly to thereby provide torque to the differential assembly, the drive pinion extending along a drive pinion axis that overlaps or intersects the axle shaft axis at an angle such that a plane extending along the axle shaft axis and orthogonal to the drive pinion axis defines first and second sides of the axle housing, the first and second sides being opposing sides of the axle housing, the drive pinion is configured to flank the at least one axle shaft so as to be directly driven by the electric motor at the first side of the axle housing and to engage the differential assembly at the second side of the axle housing. Other embodiments of this aspect include corresponding computer systems, apparatus, and computer programs recorded on one or more computer storage devices, each configured to perform the actions of the methods.

Implementations may include one or more of the following features. Axle assembly may include a gear reduction module that operatively connects the drive pinion to the electric motor, the gear reduction module transmits torque from the electric motor to the differential assembly at a reduced speed. Axle assembly where the reduced speed corresponds to a gear ratio between about 1.5:1 and 2.5:1. Axle assembly where the gear reduction module comprises parallelly offset gears. Axle assembly where an offset of the parallelly offset gears is such that the drive pinion is allowed to pass over a top of or under the at least one axle shaft. Axle assembly may include a drive pinion bearing disposed along the drive pinion at a position that is more distal to the first side of the axle housing than is the drive pinion. Axle assembly where the drive pinion engages the differential assembly at the second side of the axle housing. Axle assembly may include a gear reduction module that operatively connects the drive pinion to the electric motor, the gear reduction module being positioned at the first side of the axle housing such that the drive pinion engages the differential assembly at a position that is between the gear reduction module and the drive pinion bearing. Axle assembly may include a drive pinion bearing cage that encloses the drive pinion bearing and is removably attachable to the axle housing so as to form a portion of an exterior of the axle housing. Axle assembly may include a differential carrier that supports the differential assembly and a shift system that is located between the differential carrier and a mounting surface at which of the electric motor that attaches to the axle assembly. Axle assembly may include a gear reduction module that has a planetary gear assembly that is arranged about a driveshaft that is configured to be driven by the electric motor, the driveshaft having a driveshaft gear that meshes with a drive pinion gear of the drive pinion to operatively connect to the drive pinion to thereby transmit torque from the electric motor to the differential assembly at a reduced speed. Axle assembly may include the electric motor, and where the electric motor is at least one of: enclosable in an electric motor housing that is attachable to the axle housing and a sealed electric motor. Implementations of the described techniques may include hardware, a method or process, or a computer tangible medium.

In one general aspect, drivetrain may include A drivetrain. Other embodiments of this aspect include corresponding computer systems, apparatus, and computer programs recorded on one or more computer storage devices, each configured to perform the actions of the methods.

Implementations may include one or more of the following features. Drivetrain where the drivetrain is integrated into a powertrain for powering a vehicle, the powertrain having a motive power source that is operatively connected to the drivetrain to provide torque to provide torque to one or more traction wheel assemblies that are operatively connected to the at least one axle assembly. Drivetrain where the powertrain is integrated into a vehicle. Drivetrain where a driveshaft of the electric motor is operatively connected to the drive pinion via a gear reduction module and is radially offset from the drive pinion. Method the method having: placing the drive pinion within an axle housing of the at least one axle assembly such that the drive pinion engages a driveshaft of the electrical motor at a forward side of the axle assembly that is forward of an axle axis along which at least one axle is receivable in the at least one axle assembly; and placing the drive pinion in engagement with a differential assembly of the at least one axle assembly such that the drive pinion engages the differential assembly at a rear side of the axle assembly that is rearward of the axle axis such that the drive pinion flanks the axle axis in a forward-rear direction and is offset from the driveshaft of the electric motor. Implementations of the described techniques may include hardware, a method or process, or a computer tangible medium.

In one general aspect, method may include receiving a torque that is provided along a first axis at a first portion of the axle assembly that is forward of an axle axis along which at least one axis of the axle assembly is receivable. Method may also include transmitting the torque from the first axis to a second axis that is parallelly offset from the first axis, each of the first and second axes being angled relative to the axle axis. Method may furthermore include engaging a differential assembly at a second portion of the axle assembly that is opposite the first portion to thereby provide the torque to one or more traction wheel assemblies that are operatively connected to the axle assembly. Other embodiments of this aspect include corresponding computer systems, apparatus, and computer programs recorded on one or more computer storage devices, each configured to perform the actions of the methods.

Implementations may include one or more of the following features. Method where the transmitting the torque comprises transmitting the torque at a reduced speed. Method where the engaging the differential assembly comprises engaging an aft portion of the differential assembly. Implementations of the described techniques may include hardware, a method or process, or a computer tangible medium.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 is a schematic diagram of a dual-axle multi-mode adjustable hybrid vehicle system with integrated front axle;

FIG. 2 is a schematic diagram of an integrated axle;

FIG. 3 is a schematic diagram of another dual-axle multi-mode adjustable hybrid vehicle system with integrated front axle;

FIG. 4 is a schematic diagram of an example of a three-axle multi-mode adjustable hybrid vehicle system with integrated front axle;

FIG. 5 is a schematic diagram of an example of a three-axle multi-mode adjustable hybrid vehicle system with integrated front axle;

FIG. 6 is a schematic diagram of an example of a three-axle multi-mode adjustable hybrid vehicle system with integrated front axle;

FIG. 7 is a schematic diagram of a controller operatively coupled with other components of the system;

FIG. 8 is a perspective view of the axle assembly with a differential carrier cover of the axle assembly shown as translucent;

FIG. 9 is a perspective view of the axle assembly with the differential carrier cover and an axle housing shown as translucent;

FIG. 10 is a perspective view of the axle assembly with the differential carrier cover and the axle housing removed to reveal a pinion cage of the axle assembly;

FIG. 11 is a perspective view of the axle assembly with the differential carrier cover and the axle housing made translucent;

FIG. 12 is a top view of the axle assembly with the differential carrier cover removed;

FIG. 13 is a perspective view of an aft portion of the axle assembly with the differential carrier cover and the axle housing removed;

FIG. 14 is a vertical cross section of the axle assembly taken through a midplane of the drive pinion with the aft portion of the axle assembly at the left-hand side of the figure and the forward portion of the axle assembly at the right-hand side of the figure;

FIG. 16 is a flow chart of a process of using an axle assembly; and

FIG. 17 is a flow chart of a process of making an axle assembly, according to principles of the present disclosure.

### DETAILED DESCRIPTION

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings. It is not beyond the scope of this disclosure to have a number (e.g., all) the features in a given embodiment to be used across all embodiments.

The present disclosure generally relates to compact eAxles and ePowertrains. More specifically, the present disclosure related to axle assemblies and related devices, systems, and methods having compact rotor bearings, high speed gear ratios, and/or wheel end reduction. Principles of the present disclosure use a drive pinion that is in the form of a cross shaft design to provide power to the final drive pinion. In examples, such axle assemblies employ a series of planetary, helical, and bevel gearing in a single axle design. In comparison, some ePowertrains require a large rotor bearing due to an electric motor being assembled over the drive pinion. Smaller diameter bearings can perform at higher speeds than larger bearings and can lead to a more compact design, which can lead to more compact vehicle design. Gears according to the present disclosure enable large reduction ratios in single-speed transmissions, enabling the use of electrical machines that run at higher speeds and therefore achieving higher power densities.

As backdrop, in examples, designs according to the present disclosure move the pinion to the opposite side of the axle to allow for a traditional motor when compared to conventional designs. Under these circumstances, the pinion is driven by a driveshaft that crosses over the axle shafts. To maintain the current height of the motor and transmission (e.g., below center), to provide more favorable drive ratios, and to eliminate the need for wheel end reduction, the cross shaft will have a helical reduction. The helical set will be driven by a planetary which has a 2-speed shifter. The planetary is driven by the electric motor, which can be a sealed and/or off the shelf product mounted to the differential carrier with an adaptor and splined shaft.

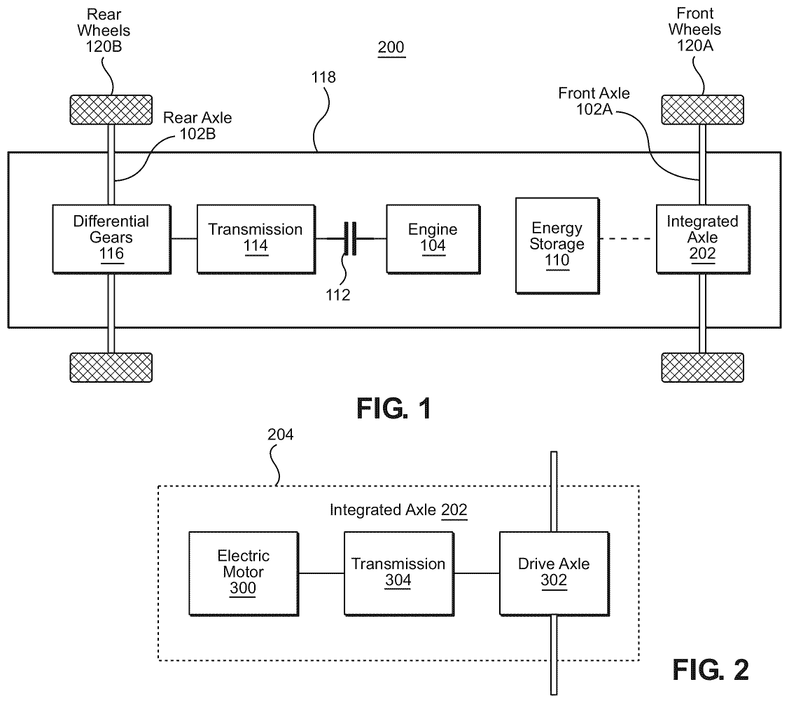

FIG. 1 shows an example of a multi-mode hybrid vehicle system 200 as disclosed herein. The system 200 includes a plurality of motive power sources. For example, an integrated axle 202 is mechanically coupled with a steerable front axle 102A such that the integrated axle 202 is used as a motive power source to provide the motive force to drive the front wheels 120A using electrical energy provided form the energy storage 110. The rear axle 102B is mechanically coupled with the differential gears 116, which is mechanically coupled with the transmission 114, which is mechanically coupled with or decoupled from the engine 104 via the clutch 112. The rear axle 102B, therefore, is controlled using the motive force provided by the engine 104, another power motive source. For simplicity, the inverter(s) for the integrated axle 202 and the fuel reservoir 108 coupled with the engine 104 are not shown.

As disclosed herein, an “integrated axle” includes a type of electric axle drive that is affixed to the wheels to rotate them. In examples, the integrated axle combines the functionality of an electric motor-generator, power electronics such as an inverter, and in some examples a cooling circuit to reduce cost and increase efficiency in a single component. Integrated axles are neither directly nor indirectly coupled with any combustion engine, thereby using solely the motor-generator included therein to provide mechanical power to a drive axle coupled thereto.

In some examples, the motor-generator of the integrated axle may be mounted on the drive axle. In some embodiments, the integrated axle is configured to reduce interfaces and components that may induce efficiency loss. Examples of such components include wires and copper cables that link the components together, plugs, bearings for rotating components, and separate cooling circuits for the electric motor and power electronics. The integrated axles are also more compact than the electric motor, the power electronics, and the cooling circuits therefor being individually installed, thus saving installation space within the chassis frames of the vehicle and allowing more room therein. Each integrated axle is configured independently of other integrated axle(s) in the system. In some examples, the integrated axle may also include a two-speed or three-speed gearbox.

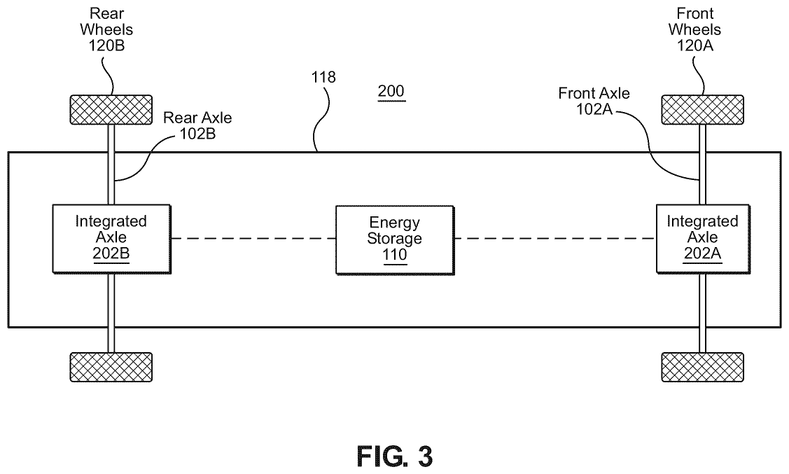

As shown in the embodiment of FIG. 1, the integrated axle 202 is mechanically coupled with a drive axle 102, such as the front axle 102A as shown in FIG. 1. The drive axle 102 is mechanically coupled with a pair of wheels 120, such as the pair of front wheels 120A as shown in FIG. 1. Although not shown, a controller is electrically coupled with the integrated axle 202. Based on the inputs received, the controller turns on (activates or engages) or turns off (deactivates or disengages) one or more of these components to achieve the different modes shown herein. FIG. 2 shows some of the components of the integrated axle 202. For example, the integrated axle 202 includes an electric motor-generator 300, a drive axle 302, and a transmission 304. Other components such as the aforementioned inverter and/or cooling circuit may be included in the integrated axle 202, as suitable. These components are separately or independently operable from the other components (e.g., the transmission 304 is separately operable from the transmission 114). The components of the integrated axle 202 (e.g., the electric motor-generator and at least a portion of the drive axle, etc.) may be mechanically mated to, coupled to, affixed to, or implemented within a common housing 204. The housing may be any suitable structure which supports the positioning of the components, as well as to provide protection of the components.

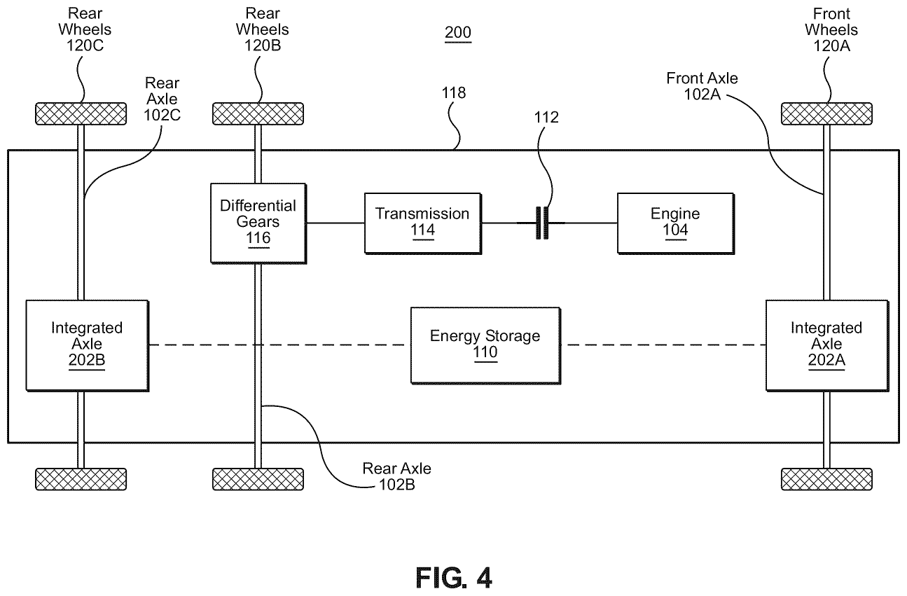

FIG. 3 shows an example of the system 200 which incorporates two integrated axles 202A and 202B, with one implemented for each of the front axle 102A and the rear axle 102B, respectively. The integrated axles 202A and 202B are operated using the controller (not shown) and the electrical energy for these axles are provided by a common energy storage 110, such as a battery or a battery pack. The two integrated axles 202A and 202B may be separately and independently operated so as to be implementable as two separate and distinct motive power sources. Each integrated axle may include the same components, including for example an electric motor and a transmission as explained herein, that are separately operable from each other, although they may be operable together simultaneously as well, as suitably controlled by the controller.

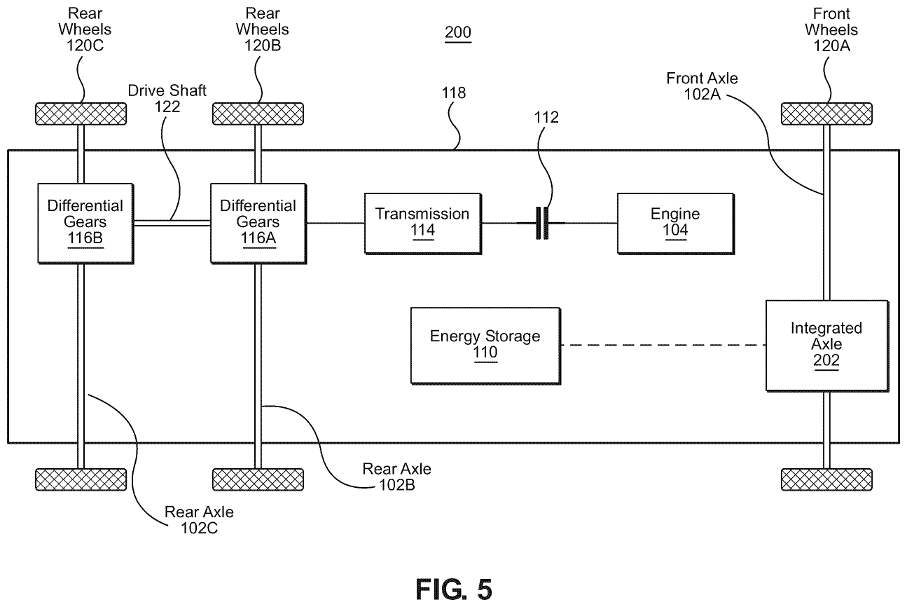

FIGS. 4 through 6 show examples of the system 200 where more than two axles (and in effect, more than four wheels) are implemented, with different combinations of integrated electrical axles and engine-powered axles implemented therein. It is to be understood that these figures are provided for illustrative purposes only, such that any additional number of axles may be implemented according to the need of the vehicle and its operation.

FIG. 4 shows an example of the system 200 which incorporates three axles 102A, 102B, and 102C, of which two of them, the front axle 102A and the rear axle 102C, have integrated axles 202A and 202B, respectively, coupled therewith. The other axle (rear axle) 102B is coupled with the engine 104 via the clutch 112, transmission 114, and differential gears 116 as shown. The integrated axles 202A and 202B are electrically powered by the energy storage 110.

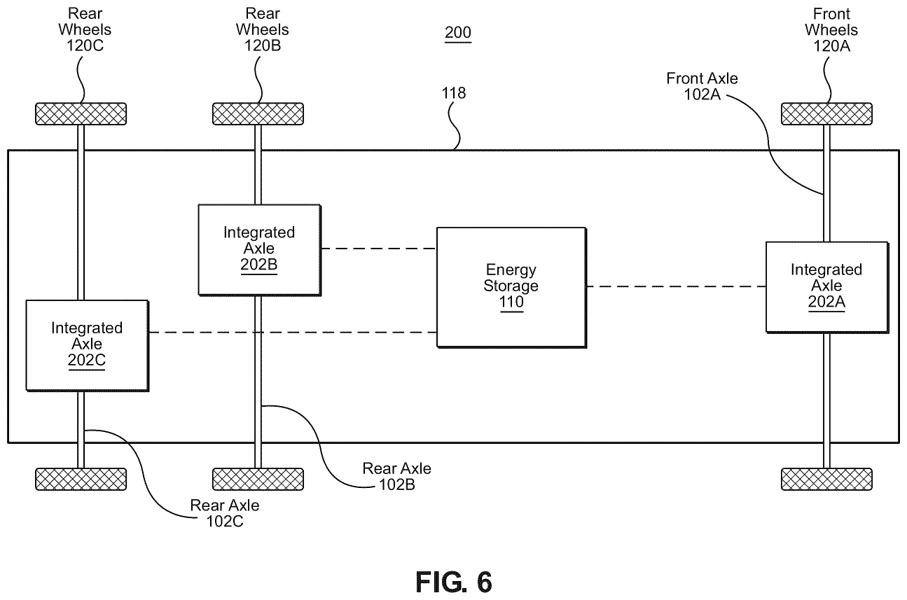

FIG. 5 shows an example of the system 200 with three axles 102A, 102B, and 102C, but instead of two integrated axles, only the front axle 102A is coupled with the integrated axle 202, and the two remaining rear axles 102B and 102C are coupled with differential gears 116A and 116B, respectively. The differential gears 116A and 116B are coupled with each other via the driveshaft 122 which may operate both of the gears simultaneously, using the power provided by the engine 104 and transferred through the transmission 114. As such, the rear axles 102B and 102C may be coupled with each other via the drift shaft 122.

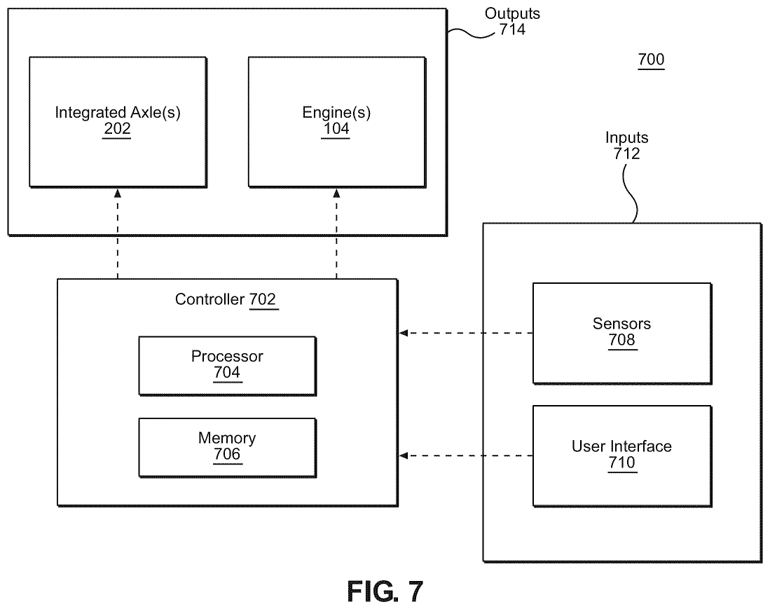

FIG. 6 shows an example of the system 200 with all three axles 102A, 102B, and 102C being powered electrically using the energy storage 110. That is, there are three integrated axles 202A, 202B, and 202C for the three axles, each independently operable, as controlled by a controller (not shown). In all examples disclosed herein, the front axle 102A is always implemented with an integrated axle, but the remaining axles may have integrated axles, engine-powered axles, or a combination of both.

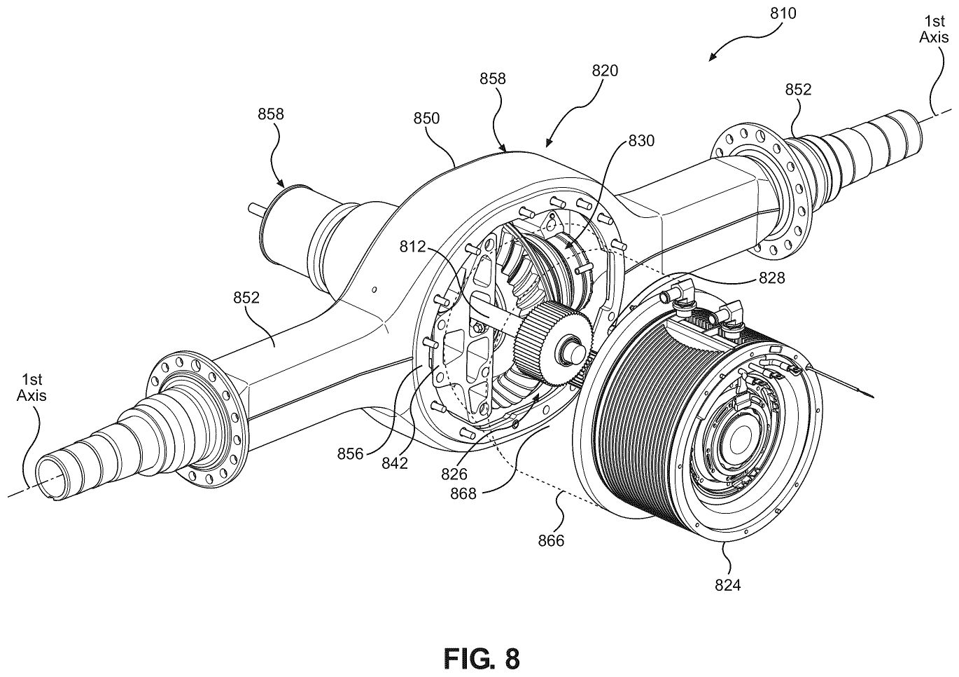

FIG. 7 shows an example of a control system 700 for the multi-mode hybrid vehicle system 200 as disclosed herein. The control system 700 includes a controller (multi-axle system controller) 702 which receives inputs 712 and controls the outputs 714. The controller 702 includes a processor 704 and a memory unit 706. The processor may be a microprocessor, a microcontroller, or any other suitable types of processing device or controller as known in the art. The controller 702 controls the operation of the integrated axle(s) 202 and engines 104 over communication lines, for example. It should be understood, however, that communication between controller and the integrated axle(s) and engine(s) may alternatively, or in addition, be performed wirelessly.

It should be understood that, in some embodiments, the controller 702 may form a portion of a processing subsystem including one or more computing devices having non-transient computer readable storage media, processors or processing circuits, and communication hardware. The controller 702 may be a single device or a distributed device, and the functions of the controller may be performed by hardware and/or by processing instructions stored on non-transient machine-readable storage media. Example processors include an application specific integrated circuit (ASIC), a field programmable gate array (FPGA), a digital signal processor (DSP), and a microprocessor including firmware. Example non-transient computer readable storage media includes random access memory (RAM), read only memory (ROM), flash memory, hard disk storage, electronically erasable and programmable ROM (EEPROM), electronically programmable ROM (EPROM), magnetic disk storage, and any other medium which can be used to carry or store processing instructions and data structures and which can be accessed by a general purpose or special purpose computer or other processing device.

Certain operations of the controller 702 described herein include operations to interpret and/or to determine one or more parameters. The parameters may be inputs 712 which may be information or data received from sensors 708 and/or user interface 710, among other means of providing inputs. The sensors may be any suitable sensor that can measure any change or increase in the load of the vehicle or the load applied on the vehicle. The sensors may include, but are not limited to, weight sensors which detect the physical weight of the vehicle and/or its cargo, gyroscopes which detect the incline or decline in which the vehicle may be traveling, and altimeters which detect the altitude or change in altitude as the vehicle travels, among others.

Interpreting or determining, as utilized herein, includes receiving sensor values by any method known in the art, including at least receiving values over communication lines, from a datalink, network communication or input device, receiving an electronic signal (e.g. a voltage, frequency, current, or pulse-width-modulation signal) indicative of the value, such as the current and expected loads of a vehicle as well as user's preference or whether the rear axles are approaching or reaching their performance limit, for example, as further explained herein, receiving a computer generated parameter indicative of the value, reading the value from a memory location on a non-transient machine readable storage medium, receiving the value as a run-time parameter by any means known in the art, and/or by receiving a value by which the interpreted parameter can be calculated, and/or by referencing a default value that is interpreted to be the parameter value.

The above-described embodiments of the technology described herein can be implemented in any of numerous ways. For example, the embodiments may be implemented using hardware, software or a combination thereof. When implemented in software, the software code (or software algorithm) can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone or any other suitable portable or fixed electronic device.

Also, a computing device may have one or more input and output devices. These devices can be used, among other things, to present the user interface 710 (which may be an output device as well as an input device). Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Such computing devices may be interconnected by one or more networks in any suitable form, including as a local area network, a controller area network, or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the disclosed embodiments may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the disclosure discussed herein. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of the disclosure, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

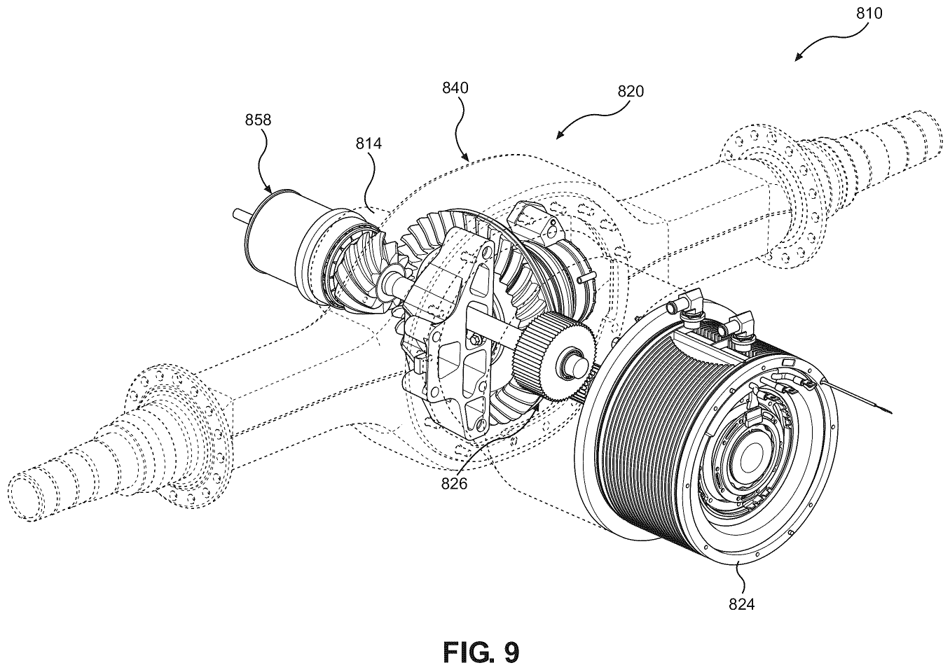

FIGS. 8-15 show various detailed views of components in an axle assembly. The axle assembly shown is an eAxle system that combine power electronics, electric motor, and transmission all in a compact system housing. As generally shown here, the axle assembly has an axle housing, a differential carrier cover mounted to the axle housing, a differential assembly mounted to a differential carrier and received in the axle housing so as to receive at least one axle, an electric motor for transmitting torque to the differential assembly via a driveshaft that drives a drive pinion through a planetary and engages the differential assembly, a gear reduction that facilitates torque transfer between the driveshaft and the drive pinion, and a transmission that operates the drive pinion at engine speed and/or some amplification thereof, according to principles of the present disclosure. It is worth reiterating that these are just some examples of the many examples disclosure herein and as such the illustrated embodiment should be construed as limiting.

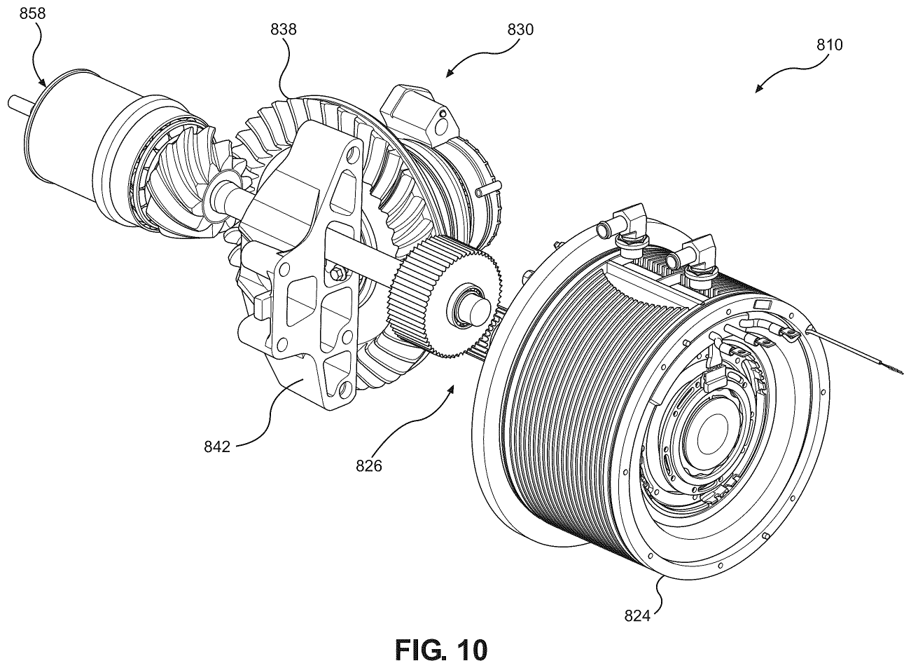

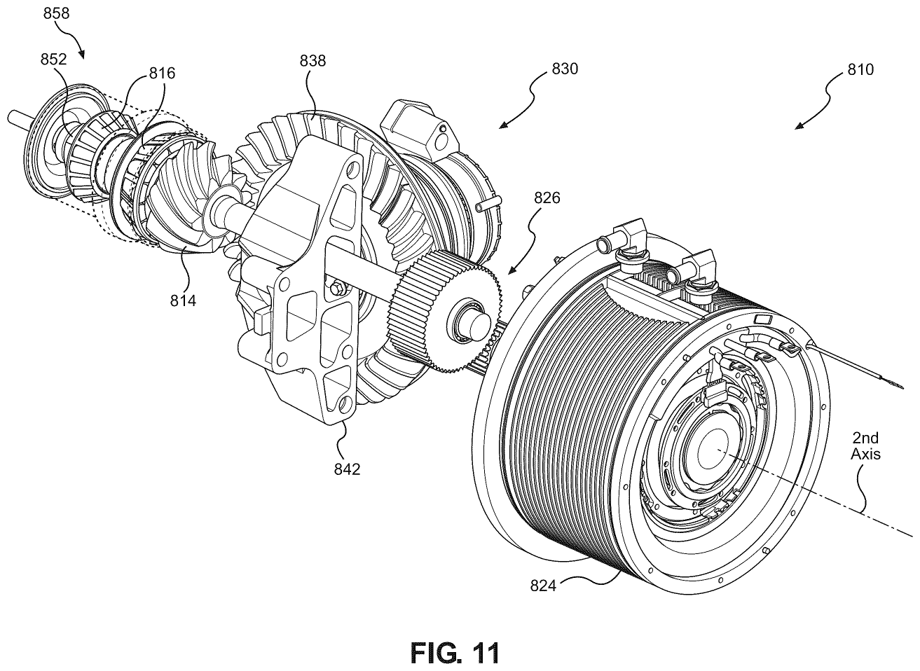

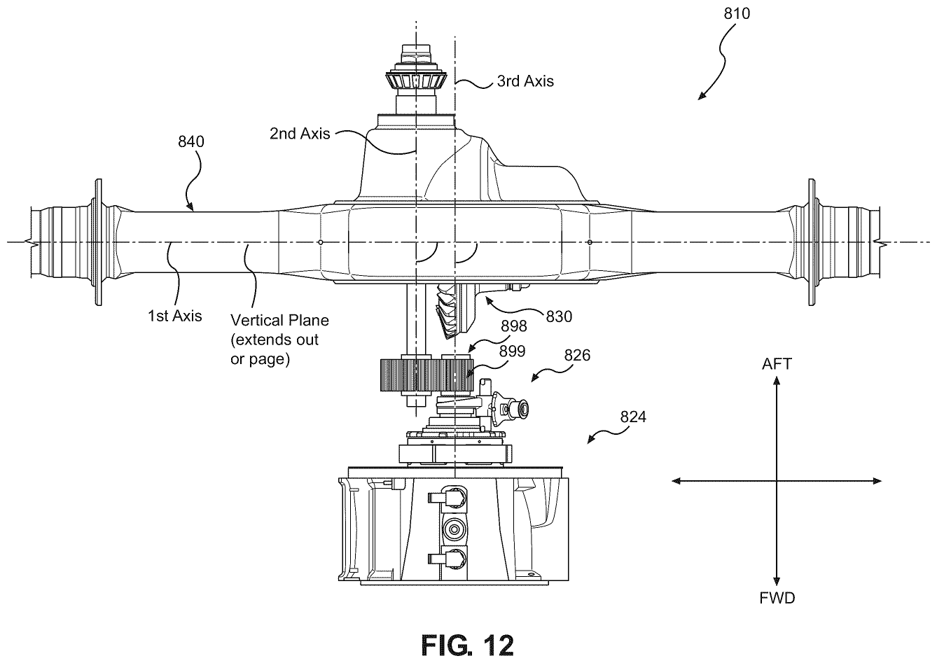

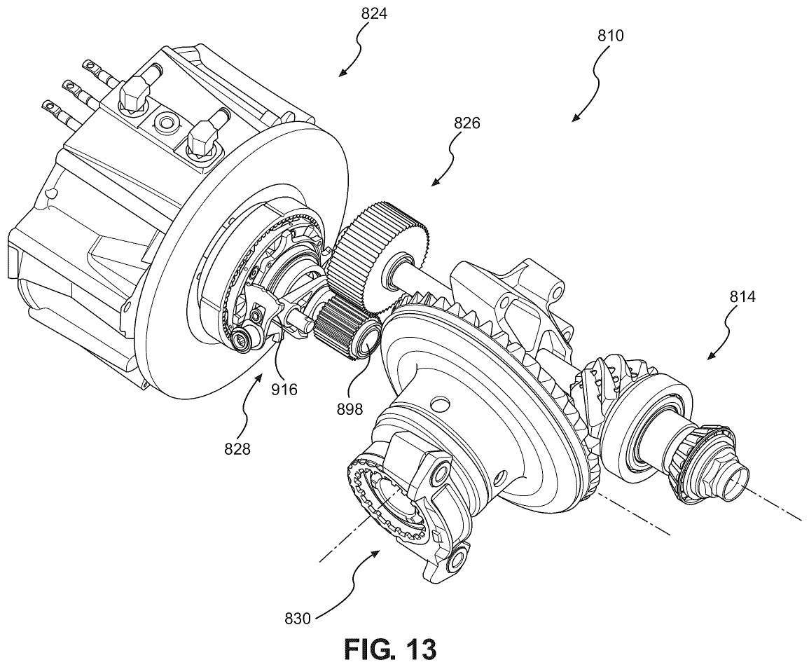

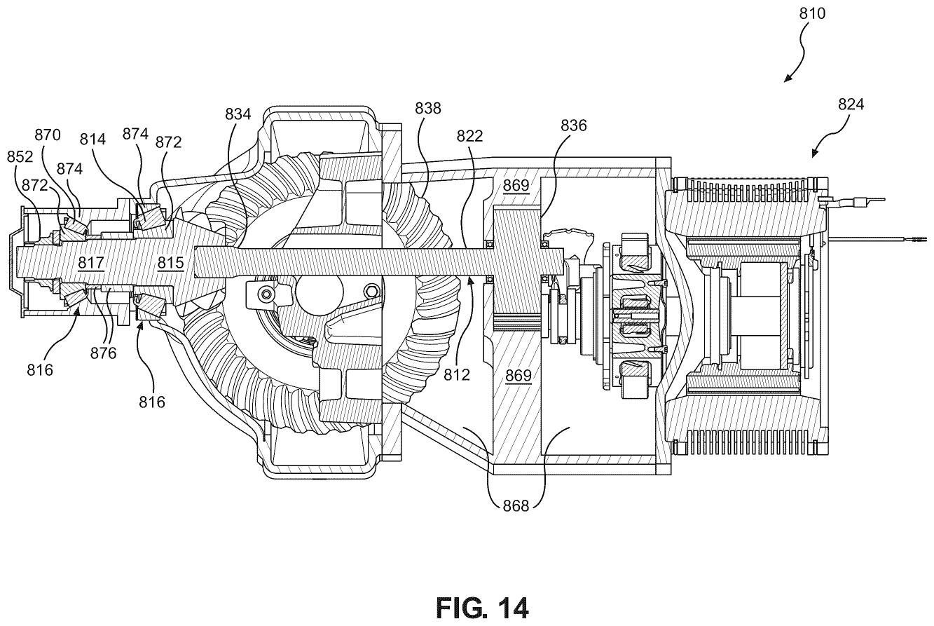

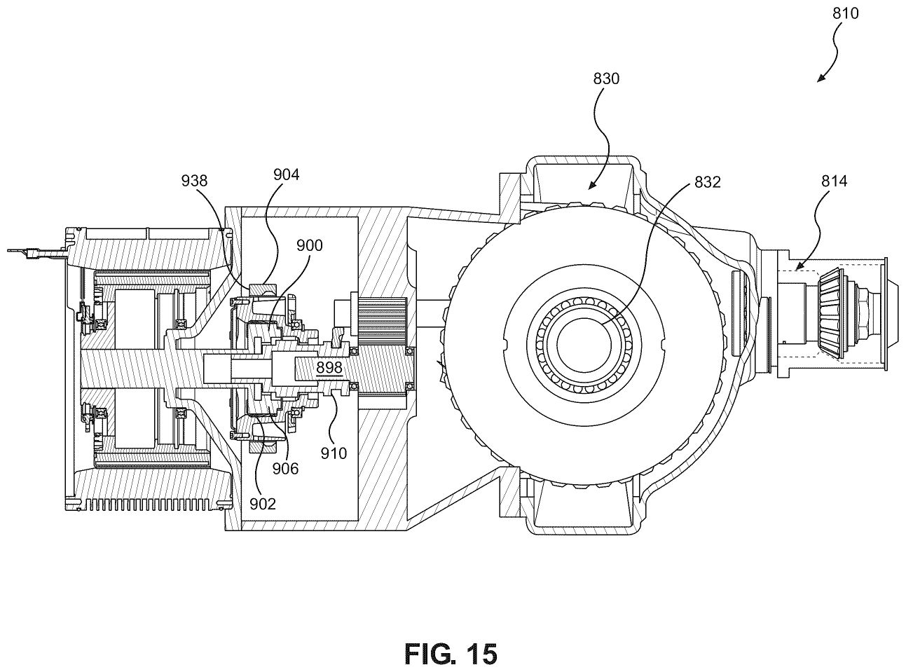

More particularly, FIG. 8 is a perspective view of the axle assembly with a differential carrier cover of the axle assembly shown as translucent. FIG. 9 is a perspective view of the axle assembly with the differential carrier cover and an axle housing shown as translucent. FIG. 10 is a perspective view of the axle assembly with the differential carrier cover and the axle housing removed to reveal a pinion cage of the axle assembly. FIG. 11 is a perspective view of the axle assembly with the differential carrier cover and the axle housing made translucent. FIG. 12 is a top view of the axle assembly with the differential carrier cover removed. FIG. 13 is a perspective view of an aft portion of the axle assembly with the differential carrier cover and the axle housing removed. FIG. 14 is a vertical cross section of the axle assembly taken through a midplane of the drive pinion with the aft portion of the axle assembly at the left-hand side of the figure and the forward portion of the axle assembly at the right-hand side of the figure. FIG. 15 is a vertical cross section of the axle assembly taken through a midplane of the driveshaft of the electric motor with the aft portion of the axle assembly at the left-hand side of the figure and the forward portion of the axle assembly at the right-hand side of the figure.

As discussed elsewhere herein, the axle assembly 810 may be provided with a motor vehicle like a truck, bus, farm equipment, mining equipment, military transport or weaponry vehicle, or cargo loading equipment for land, air, or marine vessels. The motor vehicle may include a trailer for transporting cargo in one or more embodiments. In general, the axle assembly (e.g., via a differential assembly) may be configured to transmit torque to vehicle traction wheel assemblies and may permit the traction wheel assemblies to rotate at different velocities. A drive pinion 812 may be coupled to a torque source, such as a vehicle drivetrain component like a motor. Torque that is provided to the drive pinion 812 may be transmitted to another component, such as a ring gear 838. Torque may be transmitted from the ring gear 838 to at least one axle and from an axle to at least one corresponding wheel hub and/or traction wheel assembly. The axle assembly 810 may provide torque to one or more traction wheel assemblies that may include a tire mounted on a wheel. One or more axle assemblies may be provided with the vehicle.

Beginning with more structural components, a housing assembly 820 may receive various components of the axle assembly 810. In examples, the housing assembly 820 may include an axle housing 840 and a differential carrier 842. In more detail, the axle assembly 810 may include a housing assembly 820 that houses a drive pinion 812, an electric motor 824, a gear reduction module 826, a shift mechanism 828, a differential assembly 830, and at least one axle shaft 832. The axle housing 840 may receive and support the axle shafts 832. The housing assembly 820 may facilitate mounting of the axle assembly 810 to the vehicle.

The electric motor 824 may be spaced apart from the axle housing 840 and may be disposed proximate the differential assembly 830. The electric motor 824 may be electrically coupled to a power source, such as a battery and/or capacitor that may provide and/or store electrical energy. For instance, an electrical connector module (not shown) may be provided with the electric motor 824 to facilitate electrical coupling. The electric motor 824 may provide torque to the drive pinion 812 when an electrical current is received. In addition, the electric motor 824 may generate electrical current in response to rotation of the drive pinion 812. For example, electrical current may be generated during regenerative braking or when the drive pinion 812 is rotated by a nonelectrical power source, such as an internal combustion engine.

In examples, the electric motor 824 may include a motor housing 890, a stator 892, a rotor 894, a coupling 896, and a driveshaft 898. The stator 892 may be fixedly disposed in the motor housing 890. The motor housing 890 may receive and/or support components of the electric motor 824. The motor housing 890 may be fixedly positioned with respect to differential assembly 830. The stator 892 may be radially disposed about an axis of rotation that may be coincident with a central axis of the driveshaft 898 and may include a plurality of windings as is known by those skilled in the art. The coupling 896 may be fixedly coupled to the driveshaft 898. For example, the coupling 896 may receive a portion of the driveshaft (e.g., at a splined portion of the driveshaft). A spline may be provided in the first coupling at a through hole that mates with a spline on the driveshaft. As such, the mating splines may cooperate to inhibit rotation of the coupling 896 with respect to the driveshaft 898. Further, one or more fasteners, such as a washer-nut combination, may be provided to inhibit axial movement of the coupling 896 with respect to the driveshaft 898. In this regard, a gear portion 899 of the driveshaft that is opposite the portion received by the first coupling can extend from the motor housing for engagement with a corresponding portion of the drive pinion.

Notably, the drive pinion is shown extending through the differential carrier as a cross shaft flanking the differential carrier and extending from a forward side (e.g., from the differential assembly to the electric motor) to the aft side of the axle assembly (e.g., from the differential assembly to the pinion, the transmission, and/or the roller bearing assembly). Under these circumstances, a central axis of a driveshaft of the electric motor can define a first axis (or a driveshaft axis) of the axle assembly. A central axis through the differential assembly along which one or more axles are received can define a second axis (or an axle shaft axis) of the axle assembly. And a central axis of the drive pinion can define a third axis (or a drive pinion axis) of the axle assembly. As shown, the first and third axes are parallelly offset and at an angle (e.g., orthogonal or oblique angle) relative to the second axis. Torque transmission from the electric motor to traction assemblies can occur along these axes (e.g., from the first axis, to the third axis, to the second axis).

In examples, the axle housing 840 may include a center portion 850 and at least one arm portion 852. The center portion 850 may be disposed proximate the center of the axle housing 840. The center portion 850 may define a cavity that may receive the differential assembly 830. As is best shown in FIG. 2, a lower region of the center portion 850 may at least partially define a sump portion that may contain lubricant. Splashed lubricant may flow down the sides of the center portion 850 and may flow over internal components of the axle assembly 810 and gather in the sump portion.

The center portion 850 may include a carrier mounting surface 856. The carrier mounting surface 856 may face toward and may engage the differential carrier 842. The carrier mounting surface 856 may facilitate mounting of the differential carrier 842 to the axle housing 840. For example, the carrier mounting surface 856 may have a set of holes that may be aligned with corresponding holes on the differential carrier 842. Each hole may receive a fastener, such as a bolt, that may couple the differential carrier 842 to the axle housing 840.

One or more arm portions 852 may extend from the center portion 850. For example, two arm portions 852 may extend in opposite directions from the center portion 850 and away from the differential assembly 830. The arm portions 852 may have substantially similar configurations. For example, the arm portions 852 may each have a hollow configuration or tubular configuration that may extend around the corresponding axle shaft 832 and may help separate or isolate the axle shaft 832 from the surrounding environment. An arm portion 852 or a portion thereof may be integrally formed with the center portion 850. Alternatively, an arm portion 852 may be separate from the center portion 850. In such a configuration, each arm portion 852 may be attached to the center portion 850 in any suitable manner, such as by welding or with one or more fasteners. Each arm portion 852 may define an arm cavity that may receive a corresponding axle shaft 832. It is also contemplated that the arm portions 852 may be omitted.

The differential carrier 842, which may also be called a carrier housing, may be mounted to the center portion 850 of the axle housing 840. A differential carrier cover 866 may be disposed on an end of the differential carrier 842 that may be disposed opposite the axle housing 840. The differential carrier 842 may receive the electric motor 824 and may support the differential assembly 830 in at least one cavity 868. In addition, a differential carrier cover 866 may be disposed on the differential carrier 842. For example, the differential carrier cover 866 may be mounted to interior or exterior surfaces of the axle housing and/or the differential carrier. Under these circumstances, the differential carrier cover 866 may be fixedly attached in any suitable manner, such as with one or more differential carrier cover fasteners 90, such as bolts. The differential carrier cover 866 may partially define a junction box that may receive components that may facilitate electrical connections to the electric motor 824. The differential carrier cover 866 may be provided in various configurations. For example, the differential carrier cover 866 may enclose an end of the differential carrier 842 and may not support a gear reduction module 826 in a configuration where a gear reduction module is not provided. Alternatively, the differential carrier cover 866 may support a gear reduction module 826.

A gear reduction module support 869 may be integrally formed with the differential cover 866. Alternatively, the gear reduction module support 869 may be a separate component from the differential cover 866. For example, the gear reduction module support 869 may be a protrusion of the differential cover 866. The gear reduction module may be attached to the differential cover 866 with a plurality of fasteners (not shown) such as bolts. For example, the fasteners may be arranged around a portion of the gear reduction module and may extend through a portion of the gear reduction module support 869.

Housing assembly 820 may include a cage 858 that covers at least a portion of a pinion assembly 814 to thereby form a portion of an exterior of the housing assembly. For instance, the pinion assembly can include a pinion portion 815, one or more bearings 816, and a tail portion 817 that can function as a bearing support and/or a fastener. As shown, the pinion portion is forward of the tail portion. The pinion portion can engage the differential assembly (e.g., at a ring gear 838 of the differential assembly). The tail portion has an exterior at which one or more bearings can be mounted. In this manner, the tail portion can function as a bearing support for the one or more bearings. As shown, the tail portion may support a roller bearing assembly that may rotatably support the drive pinion 812. For example, two bearing supports of the tail portion may be received in the cage and may be located proximate opposite sides of the tail portion of the pinion. As it relates to the fastener, the tail portion can have one or more engagement features (e.g., threads to engage a nut, collars to engage a sleeve, knurling for press or shrink fits, etc.).

The bearing support may be provided in various configurations, including different numbers of bearings, one or more sleeves arranged between the tail portion and a bearing, an outer race arranged around the bearing, and the like. When provided, the outer race can be fixedly positioned relative to the cage or otherwise may remain stationary, and the bearing elements of the bearing may rotate along one or more surfaces of the outer race.

More toward the dynamic portions of the axle assembly 810, the drive pinion 812 may provide torque to a ring gear 838 that may be provided with the differential assembly 830. The drive pinion 812 may extend along and may be rotatable about the first axis while the ring gear 838 may be rotatable about a second axis 112. In examples, the drive pinion 812 may extend through the differential carrier cover 866.

In examples, the drive pinion 812 may include a spline portion 834, a gear portion 836 and a shaft portion 822 disposed therebetween. The gear portion 836 may be disposed at or near a first end of the shaft portion 822. The gear portion 836 may have a plurality of teeth that may mate with corresponding teeth on the driveshaft. The spline portion 834 may be integrally formed with the shaft portion 822 or may be provided as a separate component that may be fixedly disposed on the shaft portion 822. The shaft portion 822 may extend from the gear portion 836 in a direction that extends toward the axle housing 840 and into the spline portion 834. As shown, the spline portion mates with the pinion assembly.

As noted above, the pinion assembly can include a pinion portion 815, one or more bearings 816, and a tail portion 817 that can function as a bearing support and/or a fastener. As shown, the pinion portion is forward of the tail portion. The pinion portion can engage the differential assembly (e.g., at a ring gear 838 of the differential assembly). The tail portion has an exterior at which one or more bearings can be mounted. In this manner, the tail portion can function as a bearing support for the one or more bearings. As shown, the tail portion may support a roller bearing assembly that may rotatably support the drive pinion 812. For example, two bearing supports of the tail portion may be received in the cage and may be located proximate opposite sides of the tail portion of the pinion. As it relates to the fastener, the tail portion can have one or more engagement features (e.g., threads to engage a nut, collars to engage a sleeve, knurling for press or shrink fits, etc.). For instance, a preload nut 852 may be threaded onto threads and may apply a preload force on the tail portion.

The bearing support may be provided in various configurations, including different numbers of bearings, one or more sleeves arranged between the tail portion and a bearing, an outer race arranged around the bearing, and the like. When provided, the outer race can be fixedly positioned relative to the cage or otherwise may remain stationary, and the bearing elements of the bearing may rotate along one or more surfaces of the outer race. In addition, or in alternative, an outer surface of the drive pinion may extend from the gear portion 836 and may be an outside circumference of a portion of the shaft portion 822. One or more drive pinion bearings 816 may be disposed on the outer surface and may rotatably support the drive pinion 812. The drive pinion bearings 874 may have any suitable configuration, For instance, the drive pinion bearings 874 may be configured as roller bearing assemblies that may each include a plurality of rolling elements 870 that may be disposed between an inner race 872 and an outer race 874. The inner race 872 may extend around and may be disposed on the outer surface of the drive pinion. The outer race 874 may extend around the rolling elements 870. As shown, the outer race 874 may be disposed at the cage and/or at the axle housing. One or more spacer rings 876 may be disposed between the inner races 872 of the drive pinion bearings 874 to inhibit axial movement of the drive pinion bearings 874 toward each other.

One or more bearings supports may be provided by the shaft portion 822. The bearing supports may be integrally formed with the drive pinion 812, thereby providing a unitary or one-piece construction. In the figures, two bearings are shown as supported by the shaft portion 822, although it is contemplated that one bearing support or both bearing supports may be omitted in one or more embodiments. The two bearing supports may have similar configurations. For instance, the bearing supports may be generally configured as mirror images of each other in one or more embodiments. As such, common reference numbers are used to denote features of both bearing supports.

The spline portion 834 may be disposed at a first end of the shaft portion 822 for engagement with the pinion assembly. As shown, the splines may be received by the pinion. In this regard, the gear portion 836 may be disposed opposite the spline portion 834 for engagement with the driveshaft of the electric motor (e.g., at a corresponding gear portion of the driveshaft). The spline portion 834 may include a plurality of teeth. The teeth may be disposed substantially parallel to the first axis and may mate with corresponding splines in the pinion assembly. Alternatively, the teeth of the spline may mate with a corresponding spline of an adapter that may couple the drive pinion 812 to the pinion, as is the case with other spline-to-spline connections discussed herein.

The electric motor 824 may be operatively connected to the differential assembly 830 and may provide torque to the differential assembly 830 via the drive pinion 812. As noted above, the electric motor 824 may be spaced apart from the axle housing 840 and may be disposed proximate the differential assembly 830. The electric motor 824 may be electrically coupled to a power source, such as a battery and/or capacitor that may provide and/or store electrical energy. For instance, an electrical connector module (not shown) may be provided with the electric motor 824 to facilitate electrical coupling. The electric motor 824 may provide torque to the drive pinion 812 when an electrical current is received. In addition, the electric motor 824 may generate electrical current in response to rotation of the drive pinion 812. For example, electrical current may be generated during regenerative braking or when the drive pinion 812 is rotated by a nonelectrical power source, such as an internal combustion engine.

In another examples, the electric motor 824 may be received inside the differential carrier 842. For example, the electric motor 824 may be received in the outer cavity 80 of the differential carrier 842. In addition, the electric motor 824 may be axially positioned between the differential carrier cover 866 and the axle housing 840. As such, the electric motor 824 may be completely received inside of the differential carrier 842. Positioning the electric motor 824 inside the differential carrier 842, as opposed to being mounted outside or to an end of the differential carrier 842, may help further reduce the axial length or standout of the axle assembly 810, which may reduce package space, and may position the center of mass of the axle assembly 810 closer to the axle housing 840 and the second axis 112, which may help with balancing and mounting of the axle assembly 810.

The axle shafts 832 may transmit torque from the differential assembly 830 to corresponding traction wheel assemblies. For example, two axle shafts 832 may be provided such that each axle shaft 832 extends through a different arm portion 852 of axle housing 840. The axle shafts 832 may extend along and may be rotated about the second axis by the differential assembly 830. Each axle shaft 832 may have a first end and a second end. The first end may be operatively connected to the differential assembly 830. The second end may be disposed opposite the first end and may be operatively connected to a wheel end assembly that may have a wheel hub that may support a wheel.

A gear reduction module can transmit torque along the first, second, and/or third axes at predetermine ratios. As shown, a gear reduction module includes the gear portion of the drive pinion, the gear portion of the driveshaft, and optionally, a planetary gear. Planetary gearing can increase performance when handling heavy haul loads to provide optimum safety and performance in adverse conditions due to the engineering for max traction. Optionally, gear reduction may be provided between an axle shaft and a wheel.

The gear reduction module 826, if provided, may transmit torque from the electric motor 824 to the differential assembly 830. As such, the gear reduction module 826 may be operatively connected to the electric motor 824 and the differential assembly 830. A first gear reduction of the gear reduction module can be achieved at mating gear portions of the driveshaft and the drive pinion. For instance, at this interface, there can be a drive ratio of about 2:1 (e.g., from about +/−1% to +/−15%). This is just one example of the many drive ratios contemplated by this disclosure. It should be noted that any drive ratio can be employed and may be influence by the particular application and/or environment in which the axle assembly is employed,

Further, as noted above, central axis of the driveshaft and drive pinion can be parallelly and/or radially offset. In examples, this offset can occur via a parallelly offset gearbox. The gear reduction module 826 may be provided in various configurations, such as planetary gear set configurations and non-planetary gear set configurations. An example of a gear reduction module 826 that has a planetary gear set configuration is shown. In examples, the amount of offset can be adjustable. For instance, the offset can be calculated based on a variety of factors, including gear ratio and tooth count of gears (e.g., helical gears) of the driveshaft and/or drive pinion. Further, clocking of the offset (e.g., radial position relative to the driveshaft and/or drive pinion) can strategically position the electric motor to be in alignment with the axle, Such alignment can be important for clearances, including ground, brake, and suspension clearance, Clocking and offset can be calculated together and/or be dependent upon similar factors.

The gear reduction module 826 may be primarily disposed outside of the axle housing, thereby providing a modular construction when desired. Such a configuration may allow for a standardized construction of the differential carrier 842 and/or the electric motor 824. For instance, the gear reduction module 826 may be disposed adjacent to and may be mounted to the differential carrier cover 866. In addition, the gear reduction module 826 may be primarily received or at least partially received in a gear cavity 867 of the differential carrier cover 866. As such, the gear reduction module 826 may be primarily disposed outside of the differential carrier 842.

When employing a planetary, the gear reduction module may include a sun gear 900, at least one planet gear 902, a planetary ring gear 904, and a planet gear carrier 906. The sun gear 900 may be disposed proximate the center of the planetary gear set and may be rotatable about the first axis. In addition, the sun gear 900 may extend through a portion of the differential carrier cover 866. Sun gear can define a sun gear bore that may extend along and may be centered about the first axis. The drive pinion 812 may extend through the sun gear bore and may be spaced apart from the sun gear 900.

One or more planet gears 902 may be rotatably disposed between the sun gear 900 and the planetary ring gear 904. Each planet gear 902 may have a hole and a set of teeth. The hole may be a through hole that may extend through the planet gear 902. The set of teeth may be disposed opposite the hole. The set of teeth may mesh with teeth of the sun gear 900 and teeth on the planetary ring gear 904. Bach planet gear 902 may be configured to rotate about a different planet pinion axis. The planet pinion axes may extend substantially parallel to the first axis.

The planetary ring gear 904 may extend around the first axis and may receive the planet gears 902. The planetary ring gear 904 may include a plurality of teeth that may extend toward the first axis and may mesh with teeth on the planet gears 902. The planetary ring gear 904 may be fixedly positioned with respect to the differential carrier cover 866 and the first axis. For example, the planetary ring gear 904 may be received in the cavity 868 of the differential carrier cover 866 and may be fixedly disposed in the differential carrier cover 866.

The planet gear carrier 906 may be rotatable about the first axis and may rotatably support the planet gears 902. In at least one configuration, the planet gear carrier 906 may include a through hole that may extend through planet gear carrier 906, extending along and centered about the first axis. Teeth of the planet gear carrier may be arranged around the first axis and may extend toward the first axis. A roller bearing assembly 938 may extend around the planet gear carrier to rotatably support the planet gear carrier 906. The roller bearing assembly 938 may be disposed between the planet gear carrier (e.g., at a flange) and a gear reduction module support 869 disposed at the differential carrier cover 866.

The shift mechanism can be located between the differential carrier and the electric motor. The shift mechanism 828 may be disposed at an end of the axle assembly 810 that may be disposed opposite the axle housing 840. For example, the shift mechanism 828 may be disposed on the differential carrier cover 866. In at least one configuration, splines of the driveshaft may mate with corresponding splines of another component, such as a coupling or shift collar that may operatively connect the driveshaft to the power source for driving the drive pinion. For instance, the shift collar 910 may extend through components of the gear reduction module 826, such as the planet gear carrier 906. In examples, the shift collar 910 maybe operatively connected to an actuator 916. The actuator 916 may move the shift collar 910 along the first axis between the first, second, and third positions. For example, the actuator 916 may be coupled to the shift collar 910 with the linkage 340. The actuator 916 may be of any suitable type. For example, the actuator 916 may be an electrical, electromechanical, pneumatic or hydraulic actuator.

The gear reduction module 826 may cooperate with the shift mechanism 828 to provide a desired gear reduction ratio to change the torque provided from the electric motor 824 to the differential assembly 830, and hence to the axle shafts 832 of the axle assembly 810. For example, the gear reduction module 826 may provide a first drive gear ratio and a second drive gear ratio. The first drive gear ratio, which may be referred to as a low range gear ratio, may provide gear reduction from the electric motor 824 to the differential assembly 830 and hence to the axle shafts 832. As a nonlimiting example, the first drive gear ratio may provide a 2:1 gear ratio or more. The first drive gear ratio may provide increased torque to a vehicle traction wheel as compared to the second drive gear ratio. The second drive gear ratio, which may be referred to as a high range gear ratio, may provide a different gear reduction ratio or lesser gear reduction ratio than the first drive gear ratio. For instance, the second drive gear ratio may provide a 1:1 gear ratio. The second drive gear ratio may facilitate faster vehicle cruising or a cruising gear ratio that may help improve fuel economy. In addition, a neutral drive gear ratio or neutral position may be provided in which torque may not be provided to the differential assembly 830 by the electric motor 824.

An electronic controller may control operation of the actuator 916 and hence movement of the shift collar 910. An example of shifting of the shift collar 910 will now be discussed in the context of an axle assembly 810 that has a gear reduction module 826 having a planetary gear configuration. Starting with the shift collar 910 in the first position, the electronic controller may receive one or more inputs that may be indicative of speed (e.g., rotational speed of the rotor 164) and/or torque (e.g., torque provided by the electric motor). Shifting of the shift collar 910 from the first position to the second position or neutral position may be commenced when the speed and/or torque exceed predetermined threshold levels. Torque on the shift collar 910 may be temporarily relieved or reduced by controlling the rotational speed of the electric motor so that the shift collar 910 may more easily be actuated from the first position to the second position. The shift collar 910 may then be actuated from the second position to the third position. More specifically, the rotational speed of the shift collar 910 may be synchronized with the rotational speed of the sun gear 900 and then the actuator 916 may be controlled to move the shift collar 910 from the second position to the third position. The steps may be generally reversed to move the shift collar 910 from the third position to the first position. For instance, torque on the shift collar 910 may be temporarily relieved or reduced to allow the shift collar 910 to move from the third position to the second position and rotational speed of the shift collar 910 and planet gear carrier 906 may be synchronized to allow the shift collar 910.

The axle assembly described above may allow an electric motor to be assembled to or retrofitted on an existing axle housing. In addition, a gear reduction module or gear reduction module accompanied by a shift mechanism may optionally be provided to provide gear reduction that may improve vehicle traction at low speeds or on increased road grades. The modular end-to-end positioning of the gear reduction module and the shift mechanism may allow gear reduction modules and shift mechanisms to be added to or removed from an axle assembly to meet operating conditions or performance requirements. Moreover, the modular construction may allow components such as the differential carrier, differential carrier cover, and shift mechanism housing to be made of a lighter weight material, such as aluminum, as compared to the axle housing, which may help reduce weight and improve fuel economy. The removable end plate may also allow the axle assembly to be coupled to a driveshaft which may allow the axle assembly to be provided as part of a parallel hybrid driveline rather than an all-electric configuration.

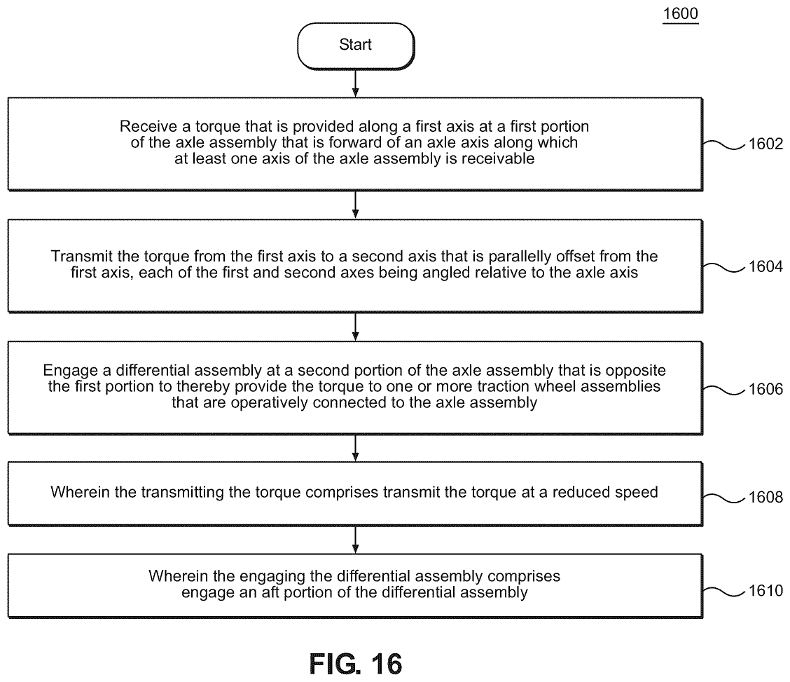

FIG. 16 is a flow chart of a process 1600, according to an example of the present disclosure. According to an example, one or more process blocks of FIG. 16 may be performed by axle assembly.

As shown in FIG. 16, process 1600 may include receiving a torque that is provided along a first axis at a first portion of the axle assembly that is forward of an axle axis along which at least one axis of the axle assembly is receivable (block 1602). For example, axle assembly may receive a torque that is provided along a first axis at a first portion of the axle assembly that is forward of an axle axis along which at least one axis of the axle assembly is receivable, as described above. As in addition shown in FIG. 16, process 1600 may include transmitting the torque from the first axis to a second axis that is parallelly offset from the first axis, each of the first and second axes being angled relative to the axle axis (block 1604). For example, axle assembly may transmit the torque from the first axis to a second axis that is parallelly offset from the first axis, each of the first and second axes being angled relative to the axle axis, as described above. As also shown in FIG. 16, process 1600 may include engaging a differential assembly at a second portion of the axle assembly that is opposite the first portion to thereby provide the torque to one or more traction wheel assemblies that are operatively connected to the axle assembly (block 1606). For example, axle assembly may engage a differential assembly at a second portion of the axle assembly that is opposite the first portion to thereby provide the torque to one or more traction wheel assemblies that are operatively connected to the axle assembly, as described above.

Process 1600 may include additional implementations, such as any single implementation or any combination of implementations described below and/or in connection with one or more other processes described elsewhere herein. In a first implementation, the transmitting the torque comprises transmitting the torque at a reduced speed.

In a second implementation, alone or in combination with the first implementation, the engaging the differential assembly comprises engaging an aft portion of the differential assembly.

It should be noted that while FIG. 16 shows example blocks of process 1600, in some implementations, process 1600 may include additional blocks, fewer blocks, different blocks, or differently arranged blocks than those depicted in FIG. 16. Additionally, or alternatively, two or more of the blocks of process 1600 may be performed in parallel.

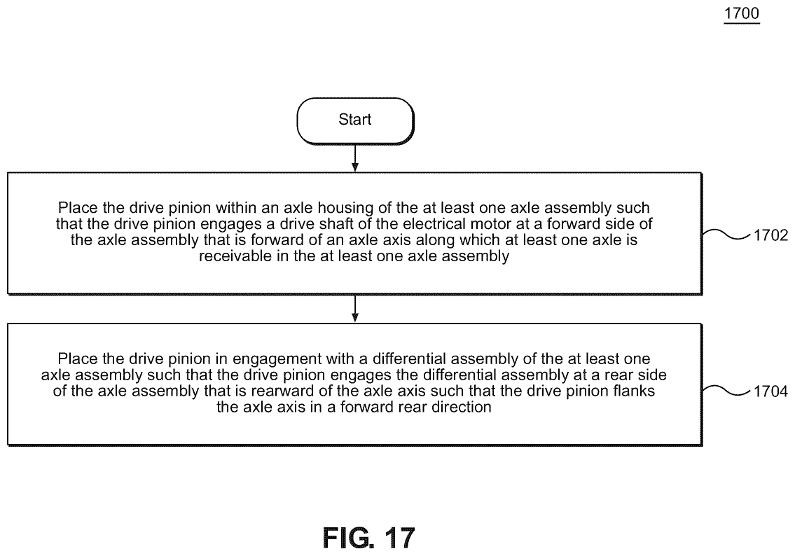

FIG. 17 is a flow chart of a process 1700, according to an example of the present disclosure. According to an example, one or more process blocks of FIG. 17 may be performed by axle assembly.

As shown in FIG. 17, process 1700 may include placing the drive pinion within an axle housing of the at least one axle assembly such that the drive pinion engages a driveshaft of the electrical motor at a forward side of the axle assembly that is forward of an axle axis along which at least one axle is receivable in the at least one axle assembly (block 1702). For example, axle assembly may place the drive pinion within an axle housing of the at least one axle assembly such that the drive pinion engages a driveshaft of the electrical motor at a forward side of the axle assembly that is forward of an axle axis along which at least one axle is receivable in the at least one axle assembly, as described above. As in addition shown in FIG. 17, process 1700 may include placing the drive pinion in engagement with a differential assembly of the at least one axle assembly such that the drive pinion engages the differential assembly at a rear side of the axle assembly that is rearward of the axle axis such that the drive pinion flanks the axle axis in a forward-rear direction (block 1704). For example, axle assembly may place the drive pinion in engagement with a differential assembly of the at least one axle assembly such that the drive pinion engages the differential assembly at a rear side of the axle assembly that is rearward of the axle axis such that the drive pinion flanks the axle axis in a forward-rear direction, as described above.

It should be noted that while FIG. 17 shows example blocks of process 1700, in some implementations, process 1700 may include additional blocks, fewer blocks, different blocks, or differently arranged blocks than those depicted in FIG. 17. Additionally, or alternatively, two or more of the blocks of process 1700 may be performed in parallel.

Perhaps best understood in the context of specific examples, principles of the present disclosure will now be discussed as example implementations thereof. Other example implementations will be apparent to those having ordinary skill in the art and are indeed contemplated if not discussed at length for sake of conciseness. Indeed, these example implementations are just some of those contemplated and discussed herein and, thus, are well within the scope of this disclosure. Though made without reference to any particular figures, discussion of these example implementations is steeped in the principles discussed elsewhere herein. Further, discussion of one example (e.g., a first example) does not precluded inclusion of aspects or the whole in other examples (e.g., a second example).

In Example 1, an axle assembly configured to provide torque from an electric motor to one or more traction wheel assemblies for propelling a vehicle, the axle assembly being operatively connectible to the electric motor and comprising: an axle housing that is configured to support at least one axle shaft along an axle shaft axis; a differential assembly that is supported by the axle housing and transmits torque to a vehicle traction wheel assembly; and a drive pinion that is operatively engages the differential assembly to thereby provide torque to the differential assembly, the drive pinion extending along a drive pinion axis that overlaps or intersects the axle shaft axis at an angle such that a plane extending along the axle shaft axis and orthogonal to the drive pinion axis defines first and second sides of the axle housing, the first and second sides being opposing sides of the axle housing, the drive pinion is configured to flank the at least one axle shaft so as to be directly driven by the electric motor at the first side of the axle housing and to engage the differential assembly at the second side of the axle housing.

In Example 2, the axle assembly as Example 1 describes, further comprising a gear reduction module that operatively connects the drive pinion to the electric motor, the gear reduction module transmits torque from the electric motor to the differential assembly at a reduced speed.

In Example 3, the axle assembly as either of Examples 1 or 2 describe, wherein the reduced speed corresponds to a gear ratio of approximately 2:1.

In Example 4, the axle assembly as any of Examples 1-3 describe, wherein the gear reduction module comprises parallelly offset gears.

In Example 5, the axle assembly as any of Examples 1-4 describe, wherein an offset of the parallelly offset gears is such that the drive pinion is allowed to pass over a top of the at least one axle shaft.

In Example 6, the axle assembly as any of Examples 1-5 describe, further comprising a drive pinion bearing disposed along the drive pinion at a position that is more distal to the first side of the axle housing than is the drive pinion.

In Example 7, the axle assembly as any of Examples 1-6 describe, wherein the drive pinion engages the differential assembly at the second side of the axle housing.

In Example 8, the axle assembly as any of Examples 1-7 describe, further comprising a gear reduction module that operatively connects the drive pinion to the electric motor, the gear reduction module being positioned at the first side of the axle housing such that the drive pinion engages the differential assembly at a position that is between the gear reduction module and the drive pinion bearing.

In Example 9, the axle assembly as any of Examples 1-8 describe, further comprising a drive pinion bearing cage that encloses the drive pinion bearing and is removably attachable to the axle housing so as to form a portion of an exterior of the axle housing.

In Example 10, the axle assembly as any of Examples 1-9 describe, further comprising a differential carrier that supports the differential assembly and a shift system that is located between the differential carrier and a mounting surface at which of the electric motor that attaches to the axle assembly.

In Example 11, the axle assembly as any of Examples 1-10 describe, further comprising a gear reduction module that has a planetary gear assembly that is arranged about a driveshaft that is configured to be driven by the electric motor, the driveshaft having a driveshaft gear that meshes with a drive pinion gear of the drive pinion to operatively connect to the drive pinion to thereby transmit torque from the electric motor to the differential assembly at a reduced speed.

In Example 12, the axle assembly as any of Examples 1-11 describe, further comprising the electric motor, and wherein the electric motor is at least one of: enclosable in an electric motor housing that is attachable to the axle housing and a sealed electric motor.

In Example 13, a drivetrain, comprising at least one axle assembly having a rear-driven differential assembly with a forward-mounted electric motor, the axle assembly has a transmission that operatively connects an electric motor to a drive pinion with which to drive the rear-driven differential assembly.

In Example 14, the drivetrain as Example 13 describes, wherein the drivetrain is integrated into a powertrain for powering a vehicle, the powertrain comprising a motive power source that is operatively connected to the drivetrain to provide torque to provide torque to one or more traction wheel assemblies that are operatively connected to the at least one axle assembly.

In Example 15, the drivetrain as either of Examples 13 or 14 describe, wherein the powertrain is integrated into a vehicle.

In Example 16, the drivetrain as any of Examples 13-15 describe, wherein a driveshaft of the electric motor is operatively connected to the drive pinion via a gear reduction module and is radially offset from the drive pinion.

In Example 17, a method of assembling the at least one axle assembly for the drivetrain as any of Examples 13-16 describe, the method comprising: placing the drive pinion within an axle housing of the at least one axle assembly such that the drive pinion engages a driveshaft of the electrical motor at a forward side of the axle assembly that is forward of an axle axis along which at least one axle is receivable in the at least one axle assembly; and placing the drive pinion in engagement with a differential assembly of the at least one axle assembly such that the drive pinion engages the differential assembly at a rear side of the axle assembly that is rearward of the axle axis such that the drive pinion flanks the axle axis in a forward-rear direction.

In Example 18, a method of operating an axle assembly, the method comprising: receiving a torque that is provided along a first axis at a first portion of the axle assembly that is forward of an axle axis along which at least one axis of the axle assembly is receivable; transmitting the torque from the first axis to a second axis that is parallelly offset from the first axis, each of the first and second axes being angled relative to the axle axis; and engaging a differential assembly at a second portion of the axle assembly that is opposite the first portion to thereby provide the torque to one or more traction wheel assemblies that are operatively connected to the axle assembly.

In Example 19, the method as Example 18 describes, wherein the transmitting the torque comprises transmitting the torque at a reduced speed.

In Example 20, the method as either of Examples 18 or 19 describe, wherein the engaging the differential assembly comprises engaging an aft portion of the differential assembly.

Other examples of Examples 1-20 include corresponding computer systems, apparatus, and computer programs recorded on one or more computer storage devices, each configured to perform the actions of the methods. Implementations of the described techniques may include hardware, a method or process, or a computer tangible medium.

The term “flank,” meaning to be present on either side of something, can have several technical interpretations in the context of an electric axle assembly. It might describe components or systems positioned on either side of a central feature, such as the electric motor or differential. For example, in a symmetrical electric axle, the drive shafts could be said to “flank” the central motor, providing balanced torque transmission to the wheels. Alternatively, the term could apply to the placement of cooling elements, control systems, or structural supports positioned on either side of key components for stability, functionality, or thermal management. In this context, “flank” emphasizes spatial and functional relationships within the assembly, highlighting the arrangement of parts that contribute to the axle's overall performance.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An electric axle assembly configured to provide torque to at least one traction wheel assemblies for propelling a vehicle, the electric axle assembly comprising:
an axle housing that is configured to support at least one axle shaft along an axle shaft axis;
a differential assembly that is supported by the axle housing and transmits torque to the at least one traction wheel assembly;
an electric motor coupled to the axle housing; and
a drive pinion that operatively engages the electric motor and the differential assembly to thereby provide torque from the electric motor to the differential assembly, wherein the drive pinion extends along a drive pinion axis that overlaps the axle shaft axis at an angle such that a plane extending along the axle shaft axis and orthogonal to the drive pinion axis defines first and second opposite sides of the axle housing, and wherein the drive pinion is configured to flank the at least one axle shaft so as to be driven by the electric motor on the first side of the axle housing and to engage the differential assembly on the second side of the axle housing.

2. The electric axle assembly of claim 1, further comprising a gear reduction module that operatively connects the drive pinion to the electric motor, such that the gear reduction module transmits torque from the electric motor to the differential assembly at a reduced speed.

3. The electric axle assembly of claim 2, wherein the reduced speed corresponds to a gear ratio between about 1.5:1 and 2.5:1.

4. The electric axle assembly of claim 2, wherein the gear reduction module comprises parallel offset gears.

5. The electric axle assembly of claim 4, wherein an offset of the parallel offset gears is such that the drive pinion is allowed to pass over a top of or under the bottom of at least one axle shaft.

6. The electric axle assembly of claim 1, further comprising a drive pinion bearing disposed along the drive pinion at a position that is more distal to the first side of the axle housing than is the drive pinion.

7. The electric axle assembly of claim 6, wherein the drive pinion engages the differential assembly at the second side of the axle housing, and. wherein the drive pinion is configured to flank the at least one axle shaft so as to be directly driven by the electric motor on the first side of the axle housing and to engage the differential assembly on the second side of the axle housing. 8, The electric axle assembly of claim 6, further comprising a gear reduction module that operatively connects the drive pinion to the electric motor, the gear reduction module being positioned at the first side of the axle housing such that the drive pinion engages the differential assembly at a position that is between the gear reduction module and the drive pinion bearing.

9. The electric axle assembly of claim 6, further comprising a drive pinion bearing cage that encloses the drive pinion bearing and is removably attachable to the axle housing so as to form a portion of an exterior of the axle housing.

10. The electric axle assembly of claim 1, further comprising a differential carrier that supports the differential assembly and a shift system that is located between the differential carrier and a mounting surface at which of the electric motor that attaches to the axle assembly.

11. The electric axle assembly of claim 1, further comprising a gear reduction module that has a planetary gear assembly that is arranged about a driveshaft that is configured to be driven by the electric motor, the driveshaft having a driveshaft gear that meshes with a drive pinion gear of the drive pinion to operatively connect to the drive pinion to thereby transmit torque from the electric motor to the differential assembly at a reduced speed.

12. The electric axle assembly of claim 1, further comprising the electric motor, and wherein the electric motor is at least one of: enclosable in an electric motor housing that is attachable to the axle housing and a sealed electric motor.

13. A drivetrain, comprising:
an electric axle assembly having a rear-driven differential assembly with a forward-mounted electric motor, wherein the electric axle assembly has a transmission that operatively connects an electric motor to a drive pinion with which to drive the rear-driven differential assembly at a rear side of the rear-driven differential assembly.

14. The drivetrain of claim 13, wherein the drivetrain is integrated into a powertrain for powering a vehicle, the powertrain comprising a motive power source that is operatively connected to the drivetrain to provide torque to provide torque to one or more traction wheel assemblies that are operatively connected to the at least one axle assembly.

15. The drivetrain of claim 14, wherein the powertrain is integrated into a vehicle.

16. The drivetrain of claim 13, wherein a driveshaft of the electric motor is operatively connected to the drive pinion via a gear reduction module and is radially offset from the drive pinion.

17. A method of assembling the at least one axle assembly for the drivetrain of claim 13, the method comprising:
placing the drive pinion within an axle housing of the at least one axle assembly such that the drive pinion engages a driveshaft of the electrical motor at a forward side of the axle assembly that is forward of an axle axis along which at least one axle is receivable in the at least one axle assembly; and
placing the drive pinion in engagement with a differential assembly of the at least one axle assembly such that the drive pinion engages the differential assembly at the rear side of the axle assembly that is rearward of the axle axis such that the drive pinion flanks the axle axis in a forward-rear direction and is offset from the driveshaft of the electric motor.

18. A method of operating an axle assembly, the method comprising:
receiving a torque that is provided along a first axis at a first portion of the axle assembly that is forward of an axle axis along which at least one axis of the axle assembly is receivable;
transmitting the torque from the first axis to a second axis that is parallelly offset from the first axis, each of the first and second axes being angled relative to the axle axis; and
engaging a differential assembly at a second portion of the axle assembly that is opposite the first portion to thereby provide the torque to one or more traction wheel assemblies that are operatively connected to the axle assembly.

19. The method of claim 18, wherein the transmitting the torque comprises transmitting the torque at a reduced speed.

20. The method of claim 18, wherein the engaging the differential assembly comprises engaging an aft portion of the differential assembly.
